(19) United States
(12) Patent Application Publication
(10) Pub. No.: US 2014/0297286 A1
(43) Pub. Date: Oct. 2, 2014

(54) VOICE MESSAGING LUNCHBOX

(71) Applicant: Rafael Botello, Westampton, NJ (US)

(72) Inventor: Rafael Botello, Westampton, NJ (US)

(21) Appl. No.: 13/855,156

(22) Filed: Apr. 2, 2013

(51) Int. Cl. G10L 21/00

(52) U.S. Cl. CPC G10L 21/00
USPC 704/272

(57) ABSTRACT

A voice messaging system for a lunch container comprising: a top portion; a base attached to the top portion via a zipper; a audio speaker accessible in the base; and a recorder within the base, where the recorder records audio files. The audio files may be transmitted over the audio speaker and in one particular embodiment the audio files are automatically played upon removal of the top portion from the base.

### BACKGROUND OF THE INVENTION

1. Field of Invention

The present invention relates to a voice messaging lunchbox where the lunchbox provides recording and playback function for messages.

2. Description of Related Art

Schoolchildren have been packing lunch in a lunchbox for many years. Typically the lunchbox provides a convenient means to pack and store lunch for consumption by a schoolchild. Many times a child may also use a lunch sack that is also configured to store a lunch for consumption during their lunch period. Parents often remind children of various tasks or activities prior to leaving for school. Further various activities may be planned for the child during the day or after school. It therefore would be advantageous to have a voice messaging system developed that is incorporated into a lunchbox.

### SUMMARY OF THE INVENTION

The present invention relates to a voice messaging system for a lunch container comprising: a top portion; a base attached to the top portion via a zipper; a audio speaker accessible in the base; and a recorder within the base, where the recorder records audio files. The audio files may be transmitted over the audio speaker and in one particular embodiment the audio files are automatically played upon removal of the top portion from the base.

### BRIEF DESCRIPTION OF DRAWINGS

FIG. 1 depicts a rectangular pyramid-shaped lunchbox in accordance with the present invention.

FIG. 2 depicts the rectangular pyramid-shaped lunchbox in an open position.

FIG. 3 depicts a traditional-shaped lunchbox incorporating a recording system in accordance with the present invention.

FIG. 4 depicts the traditional lunchbox that includes a recording messaging system in an open position.

### DETAILED DESCRIPTION

The present invention relates to a lunchbox that includes a voice messaging system. The voice messaging system according to the present invention enables users to leave voice messages on a recorded file stored within the lunchbox. This voice file may be automatically played when the lunchbox is opened by the child during their lunch period. Messages may be left on the recording system by the child's parents or perhaps the child may record a reminder of any particular activities in a voice file stored in the recording system. The present invention provides an audio speaker and a recording mechanism incorporated in the lunchbox.

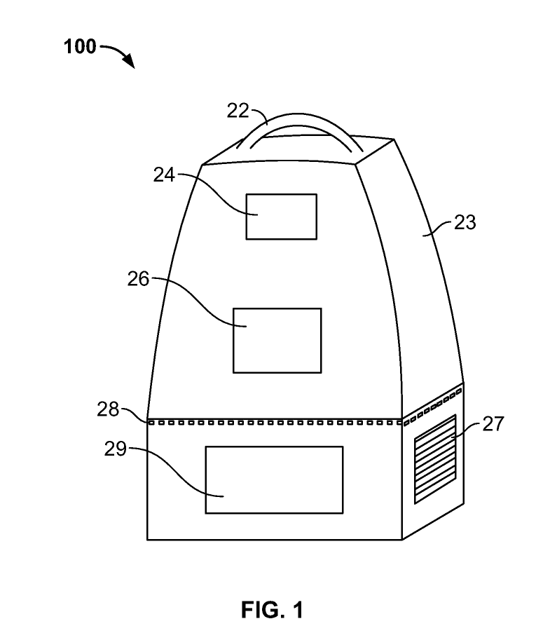

In reference to FIG. 1, a rectangular pyramid-shaped lunchbox 100 is depicted. The lunchbox 100 includes various components that are typically associated with a lunchbox. Such components include a handle 22, a label 24, and a pocket 26. These items are provided on a top portion 23 of the lunchbox 100. A base 30 is provided for the lunchbox 100 that is connected to the top portion 23 by a zipper 28. A user unzips the zipper 28 to release the top portion 23 and allow access to the base 30. An additional pocket 29 may be provided along the base along with a mesh pocket 27.

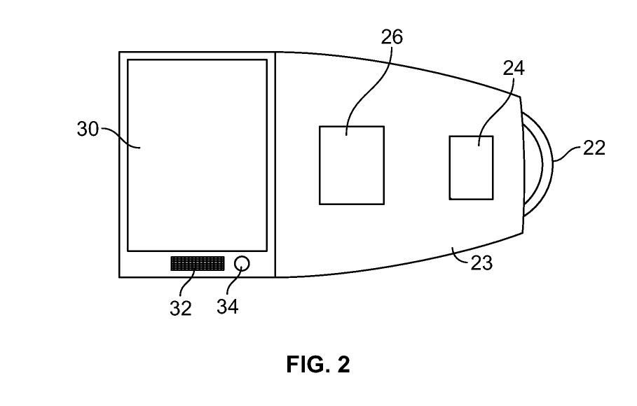

FIG. 2 depicts the lunchbox 100 in an open position. While shown in this open position the top portion 23 is extended to the side and a clear view of the interior storage area of the base 30 is depicted. Further exposed is an audio speaker 32 with a recording control button 34. During use a user typically records any audio message upon a storage means provided within the lunchbox 100. The audio file may play back once the lunchbox 100 is in this open position as shown in FIG. 2.

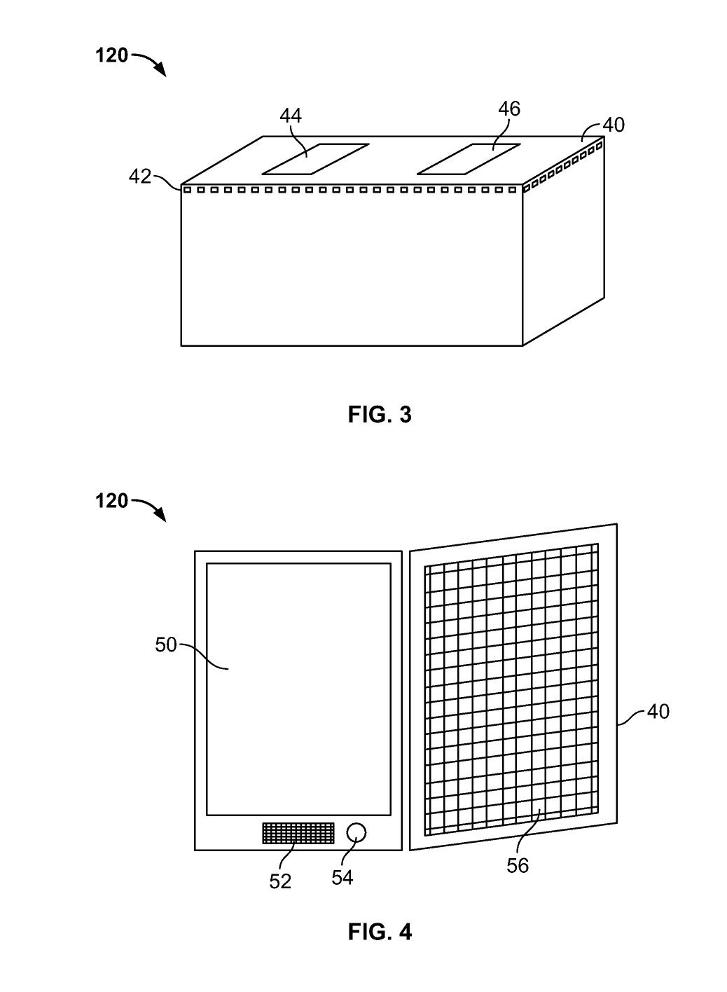

FIG. 3 depicts a traditional lunchbox, which includes a voice messaging system in accordance with the present invention. The lunchbox 120 shown in FIG. 3 includes a lid 40, which is attached to a base 50 via a zipper 42. The lid 40 further may include a label 46 and a pocket 44. Once placed in an open position, as shown in FIG. 4, the lid shows a mesh pocket on the interior side thereof. Further an audio speaker 52 and a recording button 54 are exposed. The interior 50 of the box 120 is further depicted in FIG. 4.

Programming may be associated with the playback of audio files in either embodiment of the present invention. Consequently a parent may record a particular message for playback once the lunchbox is in an open position. This feature provides a child with an immediate reminder of any various daily tasks or activities that are required. Though not shown the lunchbox recording system might be battery operated and shaped in any suitable means conducive for packing and storing a lunch. The instant invention has been shown and described in what it considers to be the most practical and preferred embodiments. It is recognized, however, that departures may be made there from within the scope of the invention and that obvious modifications will occur to a person skilled in the art.

What is claimed is:

1. A voice messaging system for a lunch container comprising:
a. a top portion;
b. a base attached to the top portion via a zipper;
c. a audio speaker accessible in the base; and
d. a recorder within the base, where the recorder records audio files.

2. The voice messaging system according to claim 1 where audio files are transmitted over the audio speaker.

3. The voice messaging system according to claim 2, where the audio files are automatically played upon removal of the top portion from the base.
